(19) United States
(12) Patent Application Publication
(10) Pub. No.: US 2014/0035837 A1
(43) Pub. Date: Feb. 6, 2014

(54) USING A DISPLAY DEVICE TO CAPTURE INFORMATION CONCERNING OBJECTIVES IN A SCREEN OF ANOTHER DISPLAY DEVICE

(71) Applicants: YI-WEN CAI, Tu-Cheng (TW); CHUN-MING CHEN, Tu-Cheng (TW); CHUNG-I LEE, Tu-Cheng (TW)

(72) Inventors: YI-WEN CAI, Tu-Cheng (TW); CHUN-MING CHEN, Tu-Cheng (TW); CHUNG-I LEE, Tu-Cheng (TW)

(21) Appl. No.: 13/647,457

(22) Filed: Oct. 9, 2012

Related U.S. Application Data
(63) Continuation-in-part of application No. 13/563,865, filed on Aug. 1, 2012.

(51) Int. Cl. G06F 3/041

(52) U.S. Cl. 345/173

(57) ABSTRACT

Information in a screen of another display device such as a television or a computer monitor can be captured by a display device including a display unit, an image sensing unit, an input unit, and a control unit. The display unit displays images corresponding to a screen of another display device. The image sensing unit produces snapshot images corresponding to the screen. The input unit produces selection parameters in response to a selection operation corresponding to the images. The control unit determines objective(s) in the screen according to the snapshot images and the selection parameters. The control unit may transmit objective data corresponding to the objective(s) to the display unit, thereby enabling the display unit to display objective-related information corresponding to the objective according to the objective data.

### CROSS-REFERENCE OF RELATED APPLICATIONS

This application is a continuation-in-part of U.S. application Ser. No. 13/563,865 filed Aug. 1, 2012 by Cai et al., the entire disclosure of which is incorporated herein by reference.

### BACKGROUND

1. Technical Field

The present disclosure relates to a display device, and particularly to a display device which is capable of capturing information as to objectives in a screen of another display device.

2. Description of Related Art

Televisions are a useful tool to present important information such as security or emergency related messages. However, the information provided through televisions is usually quite brief and cannot satisfy viewers who desire in depth information. Although an additional electronic device such as a tablet computer or a smart phone can be used to allow the viewers to interact with the content they are viewing, the keywords of the important information usually have to be manually inputted by the viewers while mistakes are liable to appear when inputting the keywords.

Thus, there is room for improvement in the art.

### BRIEF DESCRIPTION OF THE DRAWINGS

Many aspects of the present disclosure can be better understood with reference to the drawings. The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of a display system of the present disclosure.

FIG. 2 is a schematic diagram of an embodiment of a content packet including the content related information.

FIG. 3 is a schematic diagram of displaying objective-related information through the display unit shown in FIG. 1.

FIG. 4 is a flowchart of an embodiment of a monitoring method implemented through the display system shown in FIG. 1.

FIG. 5 is a flowchart of an embodiment of step S1150 of the monitoring method in FIG. 4 implemented through the display system shown in FIG. 1.

### DETAILED DESCRIPTION

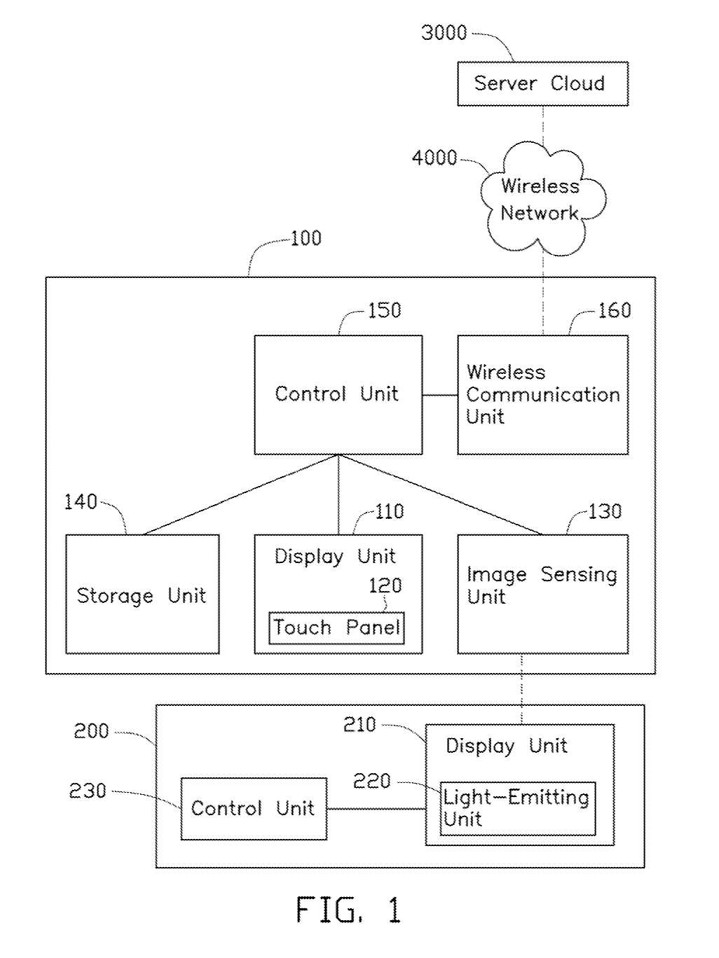

FIG. 1 is a block diagram of an embodiment of a display system of the present disclosure. The display system includes a capture device 100 and a display device 200. In the illustrated embodiment, the capture device 100 is a portable device such as a tablet computer, a smart phone, or a notebook computer. The display device 200 is a display device such as a television or a computer monitor. The display device 200 includes a display unit 210, a light-emitting unit 220, and a control unit 230. In other embodiments, the capture device 100 can be another type of electronic device capable of displaying images such as a computer monitor, and the display device 200 can be another type of electronic device capable of displaying images such as a tablet computer.

The display unit 210 displays second images G2 (not shown). The light-emitting unit 220 includes light-emitting element(s) such as light-emitting diodes (LEDs). In the illustrated embodiment, the display unit 210 includes the light-emitting unit 220 with a number of light-emitting elements, which display the second images G2 by emitting lights. In other embodiments, the light-emitting unit 220 can be independent from the display unit 210 and be disposed as, for example, a power indicator of the display device 200, which may merely include one light-emitting element. The control unit 230 may include graphics card(s) to control the display unit 210 to display the second images G2 according to an image signal received from, for example, a television antenna or a television cable. The control unit 230 further enables the light-emitting unit 220 to change a brightness of the light-emitting elements according to content related information Ic (not shown) concerning the second images G2, wherein the content related information Ic is obtained from, for example, the content of the image signal. The brightness of the light-emitting elements is changed in a range that cannot be recognized by human eyes. The content related information Ic may include the name of an objective O (not shown) in the content of the second images G2 and information concerning the objective O. The objective O can be, for example, characters, words, sentences, or graphs. The information concerning the objective O can be, for example, brief introductions of the objective O, details of the objective O, related information of the objective O, or other types of information with respect to the objective O such as hyperlinks with respect to the objective O or window components for invoking a computer program.

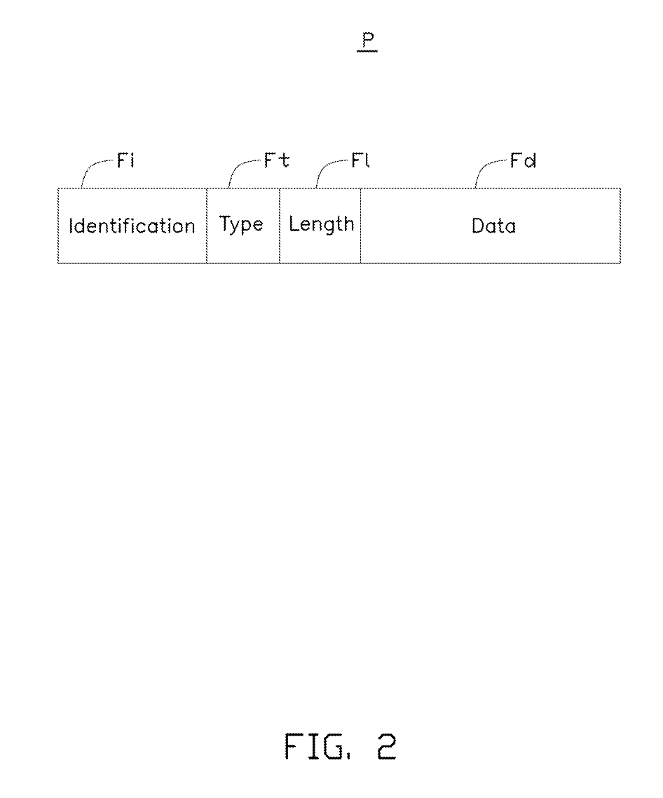

In the illustrated embodiment, the brightness of the light-emitting elements is determined by a brightness signal Sb (not shown). The control unit 230 enables the light-emitting unit 220 to change the brightness of the light-emitting unit(s) by modulating the brightness signal Sb with the content related information Ic through a modulation method such as orthogonal frequency-division multiplexing (OFDM), such that the modulated brightness signal Sb represents data structure(s) including the content related information Ic such as packet(s). FIG. 2 is a schematic diagram of an embodiment of a content packet P including the content related information Ic. In the illustrated embodiment, the modulated brightness signal Sb represents the content packet P including an identification field Fi for identifying the packet, a type field Ft including the name of the objective O in the content of the second images G2 included in the content related information Ic, a data field Fd including the information concerning the objective O included in the content related information Ic, and a length field F1 representing the length of the data field Fd. When the content of the second images G2 includes a plurality of objectives O, the brightness signal Sb is modulated to represent a plurality of content packets P each corresponding to one of the objectives O.

The capture device 100 includes a display unit 110, a touch panel 120, an image sensing unit 130, a storage unit 140, a control unit 150, and a wireless communication unit 160. In the illustrated embodiment, the display unit 110 is a liquid crystal display (LCD), which is capable of displaying first images G1 (not shown) corresponding to a screen of the display unit 210 of the display device 200, wherein the screen is a display portion of the light-emitting unit 220, which displays the second images G2. In other embodiments, the display unit 110 can be another type of electronic display such as an active-matrix organic light-emitting diode (AMOLED) display. In addition, the display unit 110 can be a transparent display such as a transparent LCD or a transparent AMOLED display allowing a user to view the first images G1, which are virtual images on the screen of the display unit 210 of the display device 200, through the display unit 110.

In the illustrated embodiment, the display unit 110 of the capture device 100 can be a device capable of displaying images such as a display panel. Meanwhile the touch panel 120 of the capture device 100 is disposed on the display unit 110 to correspond to a display portion of the display unit 110, which displays images including the first images G1, such that touch operations with respect to the touch panel 120 can be performed with respect to the first images G1. The touch panel 120 has a coordinate system corresponding to a coordinate system of the display unit 110. When a touch operation including, for example, a press (and a drag), is detected by the touch panel 120, the touch panel 120 produces touch position parameter(s) concerning the touch operation which includes coordinate(s) of the touch panel 120 concerning the touch operation. In other embodiments, another type of input device such as a mouse can be used to produce selection parameter(s) in response to a selection operation performed with respect to the first images G1.

The image sensing unit 130 of the capture device 100 produces snapshot images Gs (not shown), which includes image sensing device(s) such as camera(s) producing the snapshot images Gs. Snapshot images Gs such as still photographs or videos, wherein each of the snapshot images Gs may include a portrait of the screen of the display unit 210 of the display device 200. The image sensing unit 130 further produces the snapshot images Gs corresponding to the light-emitting element(s), wherein each of the snapshot images Gs may include a portrait of the light-emitting element(s). In other embodiments, the capture device 100 can include another image sensing unit including image sensing device(s) producing user images such as still photographs or videos, wherein each of the user images may include a portrait of the user.

The storage unit 140 of the capture device 100 is a device which stores sample objective data Ds (not shown) including sample objective figures, such as a random access memory, a non-volatile memory, or a hard disk drive for storing and retrieving digital information. The sample objective figures may include figures of possible objectives such as characters or graphs to be recognized. The control unit 150 receives the touch position parameter(s) from the touch panel 120 and the snapshot image Gs from the image sensing unit 130. The control unit 150 then determines possible objective(s) Op (not shown) through the snapshot image Gs according to the touch position parameter(s), and recognizes the objective(s) O in the screen of the display unit 210 of the display device 200 from the possible objective(s) Op according to the sample objective data Ds, thereby determining the objective(s) O.

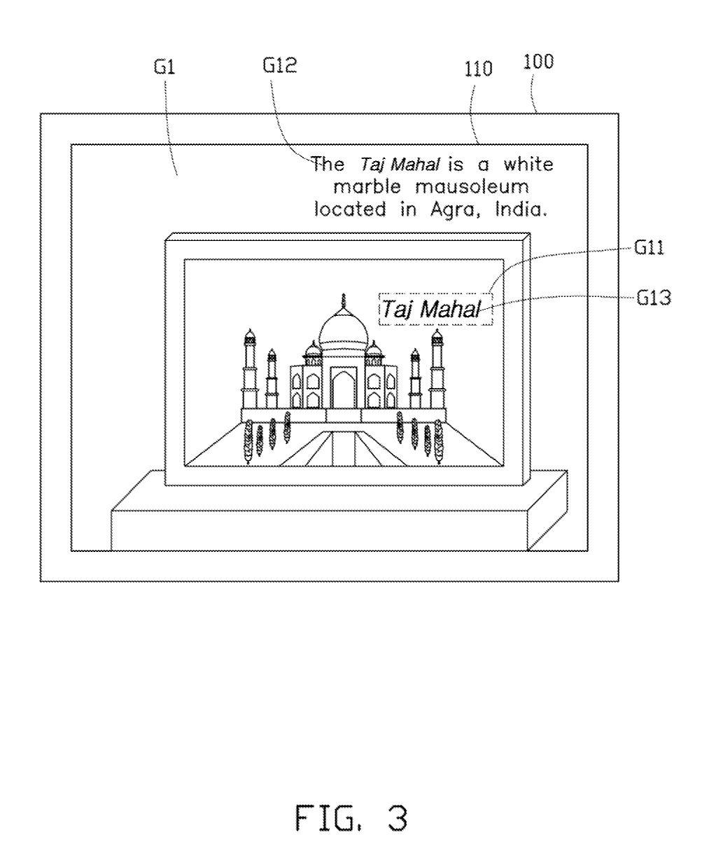

In the illustrated embodiment, the control unit 150 of the capture device 100 analyzes the snapshot image Gs to determine a portion of the snapshot image Gs including pixels having coordinates corresponding to the coordinate(s) in the touch position parameter(s) as the possible objective(s) Op. The control unit 150 compares the possible objective(s) Op with the sample objective figures in the sample objective data Ds to recognize characters and/or graphs displayed on the screen of the display unit 210 of the display device 200, and determine the objective(s) O according to the recognized characters and/or graphs. The objective(s) O can be, for example, characters, words, or sentences composed of the recognized characters, or graphs corresponding to the recognized graphs. For instance, a series of the recognized characters can be recognized as the objective(s) O when the characters compose a term. In the illustrated embodiment, the determined portion of the snapshot image Gs is highlighted through a dashed box G11 (see FIG. 3) after the objective(s) O is determined, thereby differentiating the determined portion from other portions of the screen.

In the illustrated embodiment, the control unit 150 of the capture device 100 determines the change of the brightness of the light-emitting elements according to the snapshot images Gs, retrieves the content related information Ic according to the change of the brightness of the light-emitting elements, and produces objective data Do according to the retrieved content related information Ic and the objective(s) O. When determining the change of the brightness of the light-emitting elements, the snapshot images Gs corresponding to the light-emitting element(s) are produced in a frequency higher than the change of the brightness of the light-emitting elements, such that the change can be observed through the images of the screen of the display unit 210 of the display device 200 in a series of the snapshot images Gs corresponding to the light-emitting element(s). In other embodiments, the capture device 100 can include a photodetector unit including a photodetector such as a charge-coupled device (CCD) or a photodiode. The photodetector unit produces brightness signal(s) corresponding to the brightness of the light-emitting elements. Correspondingly, the control unit 150 of the capture device 100 can determine the change of the brightness of the light-emitting elements according to the brightness signal(s).

In the illustrated embodiment, since the content packet(s) P including the content related information Ic are represented through the modulated brightness signal Sb, the control unit 150 produces a brightness change signal corresponding to the change of the brightness of the light-emitting elements, recognizes the content packet(s) P by demodulating the brightness change signal according to the modulation method, retrieves the content related information Ic by grabbing the content related information Ic from the type field Ft and the data field Fd of the content packet(s) P. The control unit 150 then compares the objective(s) O with the name of the objective O in the content of the second images G2 included in the content related information Ic, and produces the objective data Do by setting the information concerning the objective O included in the content related information Ic as the objective data Do when the name of the objective O corresponds to the objective(s) O.

In addition, the information concerning the objective(s) O can be pre-stored in the storage unit 140, or be received from a server cloud 3000 communicating with the capture device 100 through a wireless network 4000 implemented according to a telecommunication standard such as BLUETOOTH, WI-FI, and GSM (Global System for Mobile Communications). When the information concerning the objective(s) O is not found in the content related information Ic obtained from the display device 200, the control unit 150 can receive the information from the storage unit 140, or transmits request information including the objective(s) O to the server cloud 3000 and receives the information corresponding to the request information from the server cloud 3000 through the wireless communication unit 160 connected to the wireless network 4000.

In other embodiments, the storage unit 140 may include customized information such as personal information of the user 1000, such that the control unit 150 can produce the objective data Do including the information concerning the objective(s) O corresponding to the customized information. For instance, the control unit 150 can receive the information concerning the objective(s) O corresponding to the scope defined in the personal information of the user 1000, thereby providing the information, which the user 1000 requests. In addition, the capture device 100 may include sensing units for detecting environmental parameters such as location, direction, temperature, and/or humidity of the area where the capture device 100 is located, such that the control unit 150 can transmit the objective data Do including the information concerning the objective(s) O corresponding to the environmental parameters. For instance, the sensing unit can be a global positioning system (GPS) receiver which is capable of producing a location information representing latitude, longitude, and/or elevation of the capture device 100. During this time the control unit 150 can receive the information concerning the objective(s) O corresponding to the location information, thereby providing the information with respect to the location of the capture device 100, for example, the local information of the area where the capture device 100 is located.

The display unit 110 receives the objective data Do from the control unit 150. FIG. 3 is a schematic diagram of displaying objective-related information G12 through the display unit 110 shown in FIG. 1. The display unit 110 displays the objective-related information G12 according to the objective data Do. The objective-related information G12 representing the information concerning the objective(s) O is displayed on a position of the display unit 110 which is adjacent to the position of a figure G13 of the first images G1 corresponding to the objective(s) O. The control unit 150 can transmit the objective data Do in response to the movement of the objective(s) O which is caused by, for example, the movement of the capture device 100 or the change of the screen of the display device 200, while the image sensing unit 130 traces the objective O when the objective O moves, such that the objective-related information G12 can be displayed to correspond to the position of the figure G13.

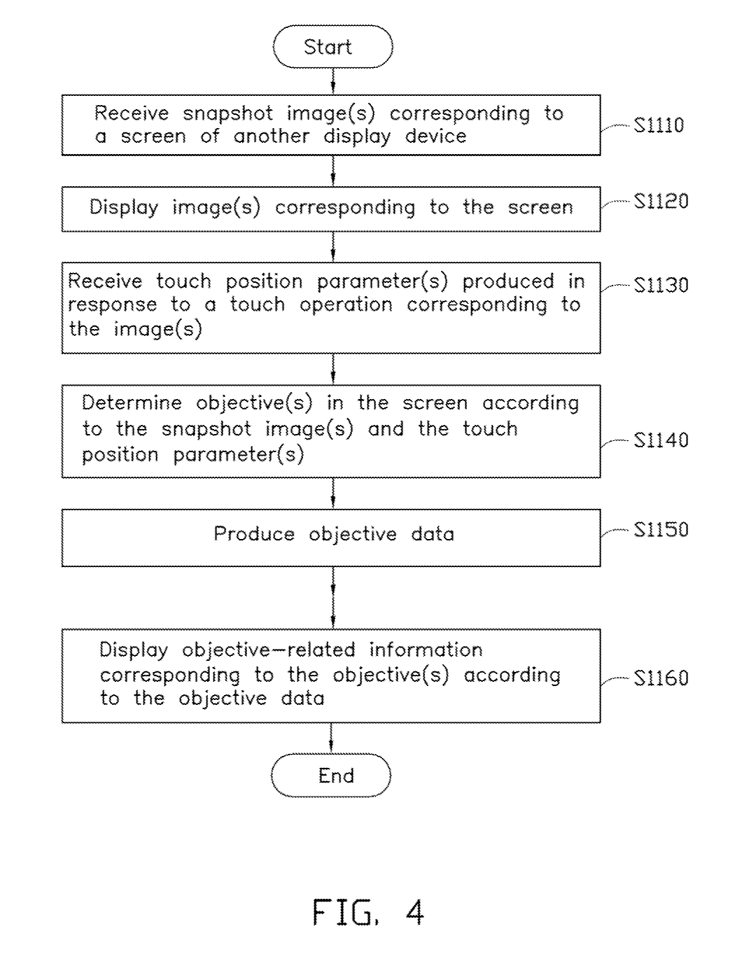

FIG. 4 is a flowchart of an embodiment of a monitoring method implemented through the display system shown in FIG. 1. The monitoring method of the present disclosure is as follows. Steps S1110-S1160 are implemented through instructions stored in the storage unit 140 of the capture device 100. Depending on the embodiment, additional steps may be added, others removed, and the ordering of the steps may be changed.

In step S1110, the snapshot images Gs corresponding to a screen of the display unit 210 of the display device 200 are received.

In step S1120, the first images G1 corresponding to the screen is displayed through the display unit 110. In the illustrated embodiment, the first images G1 are displayed on the display unit 110 according to the snapshot images Gs. In other embodiments, a transparent display allowing a user to view the screen of the display unit 210 of the display device 200 therethrough can be used to display the first images G1, wherein the first images G1 are virtual images of the screen.

In step S1130, the touch position parameter(s) produced in response to the touch operation corresponding to the first images G1 are received.

In step S1140, the objective(s) O in the screen is determined according to the snapshot images Gs and the touch position parameter(s). In the illustrated embodiment, the objective(s) O are recognized by analyzing the snapshot images Gs according to the sample objective data Ds.

In step S1150, the objective data Do is produced. In the illustrated embodiment, the objective data D is produced according to the content related information Ic obtained from the display device 200. When the information concerning the objective(s) O is not found in the content related information Ic, the information concerning the objective(s) O can be received from the server cloud 3000 by transmitting the request information corresponding to the objective O to the server cloud 3000 and receiving the information corresponding to the request information from the server cloud 3000 through the wireless communication unit 160.

In step S1160, the objective-related information G12 corresponding to the objective(s) O is displayed on the display unit 110 according to the objective data Do.

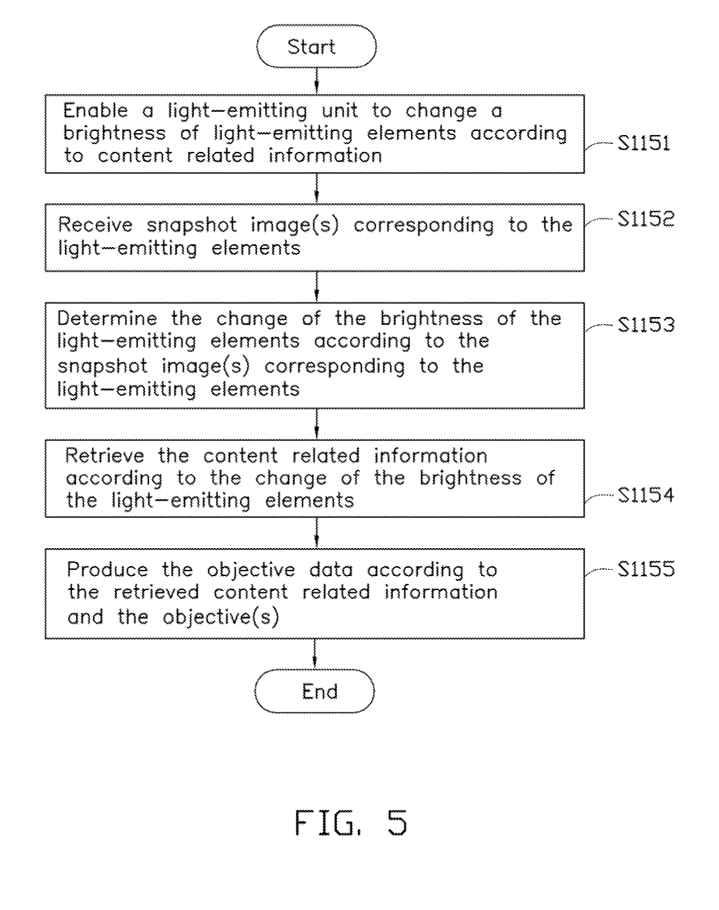

FIG. 5 is a flowchart of an embodiment of step S1150 of the monitoring method in FIG. 4 implemented through the display system shown in FIG. 1. Step S1151 is implemented through instructions stored in the control device 200; Steps S1152-S1155 are implemented through instructions stored in the storage unit 140 of the capture device 100. Depending on the embodiment, additional steps may be added, others removed, and the ordering of the steps may be changed.

In step S1151, the light-emitting unit 220 is enabled to change a brightness of the light-emitting elements according to the content related information Ic, wherein the brightness of the light-emitting elements is changed in a range that cannot be recognized by human eyes.

In step S1152, the snapshot images Gs corresponding to the light-emitting elements are received, wherein the snapshot images Gs are produced in a frequency higher than the change of the brightness of the light-emitting elements.

In step S1153, the change of the brightness of the light-emitting elements of the light-emitting unit 220 of the display device 200 are determined according to the snapshot images Gs corresponding to the light-emitting elements.

In step S1154, the content related information Ic is retrieved according to the change of the brightness of the light-emitting elements.

In step S1155, the objective data Do is produced according to the retrieved content related information Ic and the objective(s) O.

The capture device with a display unit can be used to capture information concerning objectives in a screen of another display device, and information concerning the objectives such as brief introductions or details of the objectives can be displayed through the display unit.

While the disclosure has been described by way of example and in terms of preferred embodiment, the disclosure is not limited thereto. On the contrary, it is intended to cover various modifications and similar arrangements as would be apparent to those skilled in the art. Therefore the range of the appended claims should be accorded the broadest interpretation so as to encompass all such modifications and similar arrangements.

What is claimed is:

1. A display system, comprising:
a first display device, comprising:
a display unit; and
a control unit controlling the display unit to display one or more first images; and
a second display device, comprising:
a display unit displaying one or more second images corresponding to a screen of the display unit of the first display device;
one or more image sensing units producing one or more snapshot images corresponding to the screen;
an input unit producing one or more selection parameters in response to a selection operation corresponding to the one or more second images; and
a control unit determining one or more objectives in the screen according to the one or more snapshot images and the one or more selection parameters.

2. The display system of claim 1, wherein the first display device further comprises a light-emitting unit comprising one or more light-emitting elements, the control unit of the first display device enables the light-emitting unit to change a brightness of the one or more light-emitting elements according to content related information corresponding to the one or more first images, the one or more image sensing units of the second display device produce the one or more snapshot images corresponding to the one or more light-emitting elements, the control unit of the second display device determines the change of the brightness of the one or more light-emitting elements according to the one or more snapshot images corresponding to the one or more light-emitting elements, retrieves the content related information according to the change of the brightness of the one or more light-emitting elements, and produces objective data according to the retrieved content related information and the one or more objectives, the display unit of the second display device displays one or more objective-related information corresponding to the one or more objectives according to the objective data.

3. The display system of claim 2, wherein the brightness of the one or more light-emitting elements is determined by a brightness signal, the control unit of the first display device enables the light-emitting unit to change the brightness of the one or more light-emitting units by modulating the brightness signal with the content related information.

4. The display system of claim 2, wherein the display unit of the first display device comprises the light-emitting unit and displays the one or more first images through the one or more light-emitting elements.

5. A display device, comprising:
a display unit displaying one or more images corresponding to a screen of another display device;
one or more image sensing units producing one or more snapshot images corresponding to the screen;
an input unit producing one or more selection parameters in response to a selection operation corresponding to the one or more images; and
a control unit determining one or more objectives in the screen according to the one or more snapshot images and the one or more selection parameters.

6. The display device of claim 5, wherein the display unit displays the one or more images according to the one or more snapshot images.

7. The display device of claim 5, wherein the display unit is a transparent display allowing a user to view the screen through the display unit, each of the one or more images is a virtual image of the screen seen through the display unit.

8. The display device of claim 5, wherein the one or more image sensing units produce the one or more snapshot images corresponding to the one or more light-emitting elements, the control unit determines the change of the brightness of one or more light-emitting units of the another display device according to the one or more snapshot images corresponding to the one or more light-emitting elements, retrieves the content related information according to the change of the brightness of the one or more light-emitting units, and produces objective data according to the retrieved content related information and the one or more objectives, the display unit displays one or more objective-related information corresponding to the one or more objectives according to the objective data.

9. The display device of claim 5, wherein the display unit displays one or more objective-related information corresponding to the one or more objectives according to one or more objective data, the control unit transmits the one or more objective data corresponding to the one or more objectives to the display unit.

10. The display device of claim 9, further comprising a wireless communication unit, wherein the control unit transmits one or more request information corresponding to the one or more objectives to the one or more servers through the wireless communication unit, and receives the one or more objective data corresponding to the request information from the one or more servers.

11. The display device of claim 5, wherein the input unit comprises a touch panel disposed on the display unit, the touch panel produces the one or more selection parameters comprising one or more touch position parameters in response to the selection operation comprising a touch operation with respect to the touch panel.

12. The display device of claim 5, wherein each of the one or more objectives comprises at least one of a character and a graph.

13. A display method for a display device, comprising:
receiving one or more snapshot images corresponding to a screen of another display device;
displaying one or more images corresponding to the screen;
receiving one or more selection parameters produced in response to a selection operation corresponding to the one or more images; and
determining one or more objectives in the screen according to the one or more snapshot images and the one or more selection parameters.

14. The monitoring method of claim 13, wherein the step of displaying the one or more images comprises:
displaying the one or more images according to the one or more snapshot images.

15. The monitoring method of claim 13, wherein the display device comprises a transparent display allowing a user to view the screen through the transparent display, the step of displaying the one or more images comprises:
displaying a virtual image of the screen seen through the transparent display.

16. The monitoring method of claim 13, wherein the another display device comprises one or more light-emitting units, the method further comprises:
receiving the one or more snapshot images corresponding to the one or more light-emitting elements,
determining the change of the brightness of the one or more light-emitting units of the another display device according to the one or more snapshot images corresponding to the one or more light-emitting elements;
retrieving the content related information according to the change of the brightness of the one or more light-emitting units;
producing objective data according to the retrieved content related information and the one or more objectives; and
displaying one or more objective-related information corresponding to the one or more objectives according to objective data.

17. The monitoring method of claim 13, further comprising:
displaying one or more objective-related information corresponding to the one or more objectives according to objective data.

18. The monitoring method of claim 17, wherein the display device comprises a wireless communication unit communicating with one or more server, the step of displaying the one or more objective-related information comprises:
transmitting one or more request information corresponding to the one or more objectives to the one or more servers through the wireless communication unit;
receiving the one or more objective data corresponding to the request information from the one or more servers through the wireless communication unit; and
displaying the one or more objective-related information corresponding to the one or more objectives according to the objective data.

19. The monitoring method of claim 13, wherein the display device comprises a touch panel, the step of receiving the one or more selection parameters comprises:
receiving the one or more selection parameters comprising one or more touch position parameters produced in response to the selection operation comprising a touch operation with respect to the touch panel.

20. A computer program product comprising a non-transitory computer readable storage medium and an executable computer program mechanism embedded therein, the executable computer program mechanism comprising instructions for:
receiving one or more snapshot images corresponding to a screen of another display device;
displaying one or more images corresponding to the screen;
receiving one or more selection parameters produced in response to a selection operation corresponding to the one or more images; and
determining one or more objectives in the screen according to the one or more snapshot images and the one or more selection parameters.
